(19) United States
(12) Patent Application Publication
(10) Pub. No.: US 2016/0116726 A1
(43) Pub. Date: Apr. 28, 2016

(54) THREE-DIMENSIONAL STEREOSCOPIC MICROSCOPE

(71) Applicant: FRONT STREET INVESTMENT MANAGEMENT INC., AS MANAGER FOR FRONT STREET DIVERSIFIED INCOME CLASS, Toronto (CA)

(72) Inventors: Ichiro Shinkoda, Vancouver (CA); Thomas N. Mitchell, Bowen Island (CA)

(21) Appl. No.: 14/350,182

(22) PCT Filed: Oct. 5, 2012
(86) PCT No.: PCT/IB2012/002915

§ 371 Date: Apr. 7, 2014

Related U.S. Application Data
(60) Provisional application No. 61/544,144, filed on Oct. 6, 2011.

(51) Int. Cl. G02B 21/22; G02B 21/08; G02B 21/02

(52) U.S. Cl. CPC G02B 21/22; G02B 21/02; G02B 21/086

(57) ABSTRACT

An apparatus for forming stereo image pairs comprises a set of perspective apertures within a perspective aperture plate, separated within a stereoscopic horizon by an inter-aperture distance. An offset aperture is disposed inside an illuminator of the apparatus. The offset aperture is positioned to form a cone of illumination that is mirror symmetrical with respect to the two perspective apertures. The perspective apertures are adjustable both in size and in their position within the aperture plate in order to position them with respect to a cone of light produced at the perspective aperture plate. The offset aperture is similarly adjustable in size and position. The arrangement ensures that light illuminating an object viewed using the apparatus has a narrow cone of direction and angle of incidence, which ameliorates negative effects that occur in stereoscopic systems with objective lens systems having large numerical apertures.

### FIELD OF THE INVENTION

This invention relates, in general, to stereoscopic imaging. More specifically, this invention relates to an off-axis illumination system employed in a three dimensional stereoscopic imaging system.

### BACKGROUND OF THE INVENTION

The phenomenon of stereoscopic vision, or stereopsis, is directly associated with the ability of humans and animals with binocular vision to perceive depth in a scene. It is the perceptual effect produced by the human brain simultaneously processing two sets of slightly differing two-dimensional optical data. The phenomenon, as experienced by an unaided human observer, is based on the fact that the retinal images formed by the two eyes of the observer differ slightly. A point object in a scene observed by the human observer is imaged in a slightly different position in the left retinal image as compared with the image of the same object in the same scene on the right retina.

Initially stereoscopic imagery was created using images taken by two separate cameras. Work, particularly in the video-imaging field, has led to systems in which two complete imaging systems are incorporated permanently into single stereoscopic imaging systems. Such imaging systems typically have dual optical axes and twin objective optical subsystems providing two optical paths. They typically have one optical axis for the right eye view and one for the left eye view to produce two complete images, that for the right eye perspective and that for he left eye perspective, side by side on two imaging sensors.

Some implementations of stereoscopic imaging systems have a single optical path around a central optical axis. In order to obtain a stereoscopic image pair, such systems sample different portions of the light in the single imaging path, representing two different perspectives within the field of view of the objective lens of the imaging system. Various means are employed to sample the two portions of the light in the single image path.

In applying the concepts of three-dimensional imaging to systems with large numerical apertures, there is little difficulty in securing two different perspectives of the object under study. The lens is typically close to the object and the angle subtended by it is large. Views of the object under study from drastically different angles are therefore attainable through the typical microscope objective lens.

Bigger challenges lie in the area of illumination. Direct on-axis bright-field transmitted illumination has the potential drawback of producing very little contrast, making it difficult to observe the object under study through the typical microscope while dissimilar or unbalanced illumination between the two perspective views leads to stereo image pairs that human viewers have difficulty fusing into a stereo view.

### SUMMARY OF THE INVENTION

In accordance with a first aspect of the present invention there is provided an apparatus for forming a stereoscopic image pair of an object. The apparatus comprises an objective lens disposed to collect light from the object, direct a first portion of light from the object to a first perspective aperture, and to direct a second portion of light from the object to a second perspective aperture, the light-weighted center of the second perspective aperture separated from the light-weighted center of the first perspective aperture within a stereoscopic horizon by an inter-aperture distance; an illuminator to illuminate the object, the illuminator comprising a light source, a collector to collect illuminating light from the light source and direct it to the object under study, and an offset aperture disposed between the collector and the object and configured to be positionable off the stereoscopic horizon to form a cone of illumination at a plane of the two perspective apertures substantially minor symmetrical with respect to the two perspective apertures; and a stereoscopic imaging subsystem disposed to form a first image in the stereoscopic image pair from light accepted through the first perspective aperture from the first portion of light and to form a second image in the stereoscopic image pair from light accepted through the second perspective aperture from the second portion of light.

The inter-aperture distance is adjustable to change the amount of stereopsis the apparatus.The sizes of the perspective apertures are adjustable to change the depth of focus of the apparatus. Their sizes can be independently adjustable. The positions of the light-weighted centers of the first and second perspective apertures are adjustable to partially overlap the first and second perspective apertures.

The positions of the light-weighted centers of the first and second perspective apertures are adjustable in tandem to move the stereoscopic horizon with respect to the cone of illumination. The position of the offset aperture is adjustable to move the cone of illumination with respect to the stereoscopic horizon and change an angle of incidence of illuminating light directed to the object. The size of the offset aperture is adjustable to change a range of the angle of incidence of illuminating light directed to the object. The apparatus can be a microscope, a macroscope or an endoscope.

In accordance with a further aspect there is provided an apparatus for imparting to a commercial imaging device a facility to form stereoscopic image pairs of an object, the apparatus comprising a first perspective aperture disposed to accept a first portion of light from the object receivable via an objective lens of the imaging device; a second perspective aperture disposed to accept a second portion of light from the object receivable via the objective lens of the imaging device, a light-weighted center of the second perspective aperture separated from a light-weighted center of the first perspective aperture within a stereoscopic horizon by an inter-aperture distance; and a stereoscopic imaging subsystem to form a first image in the stereoscopic image pair from light accepted through the first perspective aperture from the first portion of light and to form a second image in the stereoscopic image pair from light accepted through the second perspective aperture from the second portion of light; wherein the first and second perspective apertures are configured to be adjustably disposed substantially mirror symmetrical with respect to a cone of illumination formed off the stereoscopic horizon at a plane of the two perspective apertures by an aperture of an illuminator of the imaging device. The inter-aperture distance can be adjustable to change a stereopsis of the apparatus.The positions of the light-weighted centers of the first and second perspective apertures can be adjustable to partially overlap the first and second perspective apertures. The size of at least one of the first perspective aperture and the second perspective is adjustable to change a depth of focus of the apparatus. The positions of the light-weighted centers of the first and second perspective apertures are adjustable in tandem to move the stereoscopic horizon with respect to the cone of illumination. The imaging device to which the apparatus is applied can be for example a microscope, a macroscope or an endoscope. The aperture of the illuminator of the imaging device can be a replacement aperture configured to be offset from an optical axis of the illuminator.

In accordance with a further aspect of the present invention there is provided a method for forming a stereoscopic image pair of an object comprising directing through an objective lens a first portion of light from the object to a first perspective aperture; directing through the objective lens a second portion of light from the object to a second perspective aperture, the light-weighted center of the second perspective aperture separated from the light-weighted center of the first perspective aperture within a stereoscopic horizon by an inter-aperture distance; collecting light through a collector from a light source; directing light from the collector to the object; positioning off the stereoscopic horizon an offset aperture disposed between the collector and the object to form a cone of illumination at a plane of the two perspective apertures substantially minor symmetrical with respect to the two perspective apertures; forming a first image in the stereoscopic image pair from light accepted through the first perspective aperture from the first portion of light; and forming a second image in the stereoscopic image pair from light accepted through the second perspective aperture from the second portion of light.

The method further comprises adjusting the inter-aperture distance to change the amount of stereopsis associated with the two perspective apertures. The method further comprises adjusting the positions of the light-weighted centers of the first and second perspective apertures to partially overlap the first and second perspective apertures.The method further comprises adjusting the sizes of at least one of the first and second perspective apertures to change the depth of focus. The method further comprises adjusting the positions of the light-weighted centers of the first and second perspective apertures in tandem to move the stereoscopic horizon with respect to the cone of illumination. The method of further comprises adjusting a position of the offset aperture to move the cone of illumination with respect to the stereoscopic horizon and change an angle of incidence of illuminating light directed to the object. The method further comprises changing a size of the offset aperture to change a range of the angle of incidence of illuminating light directed to the object.

### BRIEF DESCRIPTION OF THE DRAWINGS

The objects, features, and advantages of the invention are apparent from the following detailed description taken in conjunction with the accompanying drawings in which:

FIG. 1 shows a top view of a prior art stereoscopic microscope illumination system of the Köhler type

FIG. 2 shows side view of a single-objective three-dimensional stereoscopic microscope according to the present invention.

FIG. 3 is a view along the optical axis of the three-dimensional stereoscopic microscope according to the invention.

FIG. 4 is a view along the optical axis of the three-dimensional stereoscopic microscope according to another embodiment of the invention.

### DETAILED DESCRIPTION OF AN ILLUSTRATIVE EMBODIMENT

In typical microscopes, a drawback intrudes that makes three-dimensional depth perception very difficult indeed. Since the illumination of different surfaces of the object in general differ greatly under such circumstances, the combination of human eye and brain finds it difficult to visually integrate the left eye image and right eye image to create a single three-dimensional image. Instead, the image simply appears inconsistent from one eye to the other, creating great viewing discomfort. This does not create in the human vision system a three-dimensional image, but rather an unstable and intermittent coalescence of two images that produces eyestrain. This effect is dramatically exacerbated by the above-mentioned large numerical apertures of typical microscope objective lenses as such lenses allow much greater perspective difference than that typically occurring in cameras and telescopic systems. This intermittent coalescence effect can potentially dominate over whatever three dimensional viewing is attainable with the microscope.

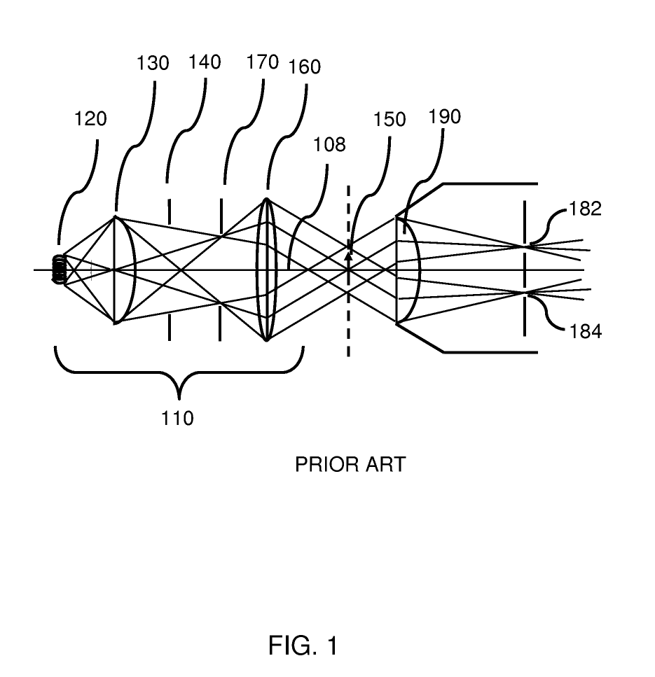

We now consider the matter of illumination in microscopes more closely. FIG. 1 shows a top view of a prior art three-dimensional stereoscopic microscope with illumination system 110 of the Köhler type, one of the most effective and industrially popular illumination systems. The Köhler illumination system has become a de facto standard in the industry. In the period predating the Köhler arrangement, microscope illuminators suffered from the fact that the usually irregularly luminescent source would be imaged on the object under study, thereby complicating viewing of the object. The Köhler arrangement introduced the approach of collecting the light from a source 120 using a collector lens 130 and passing it along an optical axis 108 through a variable field aperture 140. A variable condenser aperture 170 is typically placed before a condenser lens 160 and the image of the source 120 is typically focused on the plane of the condenser aperture 170. Instead of the source 120, the variable field aperture 140 (or a plane near it) is then imaged on the object 150 under study using the condenser lens 160.

As with other illuminator systems, the Köhler arrangement usually allows for some lateral motion of one or both of the variable field aperture 140 and the variable condenser aperture 170 off the optical axis 108. This lateral motion, however, is incorporated to allow proper centring of the apertures, the goal in general being to have all apertures and lenses centred on the same optical axis.

As seen from the image forming ray traces in FIG. 1, the Köhler arrangement causes illuminating light rays to impinge upon the object 150 at widely differing angles. When this light is directed by an objective lens 190 of a stereoscopic microscope to a right perspective aperture 182 and a left perspective aperture 184 located either side of the optical axis 108, then the illumination transmitted by the right perspective aperture 182 differs dramatically from that transmitted by the left perspective aperture 184, representing illumination of the object 150 from very different angles. This produces in any stereoscopic imaging subsystem (not shown) disposed further along optical path 108 exactly the unstable image coalescence described above.

The well-established Köhler illumination scheme, while superb for conventional two-dimensional microscopy, therefore has shortcomings when applied to the matter of stable three-dimensional imaging in microscopes. The present invention addresses the challenge of obtaining practical and stable three-dimensional viewing in a three-dimensional stereoscopic imaging system.

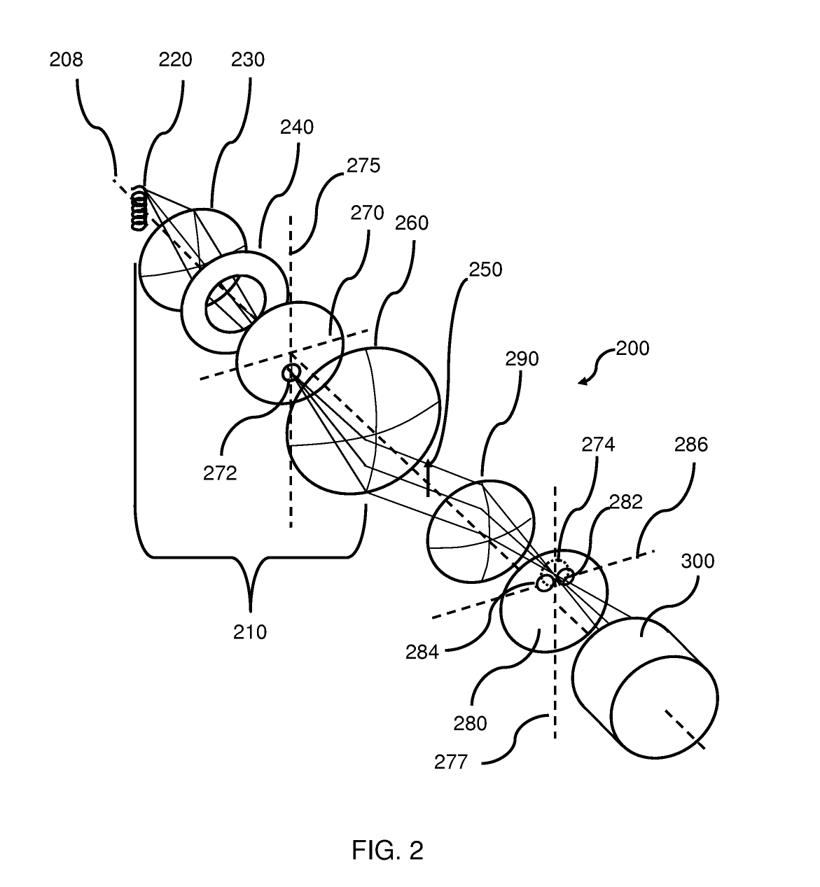

A single-objective three-dimensional stereoscopic imaging apparatus is shown generally at 200 in FIG. 2. The imaging apparatus comprises an illuminator 210 and has an optical axis 208. Light from a source 220 is collected by a collector 230 and passed through a variable field aperture 240. Collector 230 can be any optical element capable of collecting and redirecting light from source 220, such as, but not limited to, a lens, a Fresnel lens, an arrangement of minors, an array of microlenses and the like. Instead of the source 220, the variable field aperture 240, or a plane proximate it, is imaged on an object 250 under study using a condenser lens 260. Source 220 can be any source of light suitable for imaging or viewing the object 250, including, but not limited to, an incandescent lamp, a light emitting device (LED) or array of light emitting devices (LEDs), a halogen lamp, and the like. A condenser aperture plate 270 is disposed on the optical axis 208 before the condenser lens 260. The aperture 272 of the condenser aperture plate 270 is disposed off the optical axis 208 of the illumination system 210 in a fashion described in more detail below. We refer to this aperture in this specification as the “offset aperture”. The offset aperture 272 can be a variable aperture.

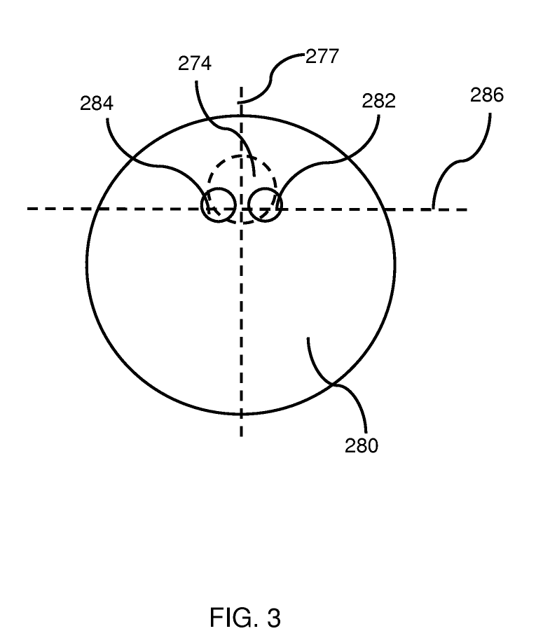

Different arrangements are possible for the single-objective three-dimensional stereoscopic imaging apparatus 200. In one embodiment of the invention, shown in FIG. 2 and FIG. 3, the imaging apparatus 200 comprises a single objective lens 290 for gathering light from the object 250 within a field of view of objective lens 290, and for directing the gathered light along a single optical path generally around the optical axis 208 through the imaging apparatus 200 to a perspective aperture plate 280 disposed in an aperture plane of the imaging apparatus. The perspective aperture plate 280 is shown in more detail in plan view in FIG. 3

A right perspective aperture 282 and a left perspective aperture 284 are disposed in the perspective aperture plate 280, their light-weighted centers separated from each other by an inter-aperture distance along a straight stereoscopic horizon line 286 through the light-weighted centers of the right perspective aperture 282 and the left perspective aperture 284. The right perspective aperture 282 samples light from a first portion of the single optical path and the left perspective aperture 284 samples light from a second portion of the single optical path. The plane defined by the stereoscopic horizon line 286 and extending parallel to the optical axis 208 is referred to in this specification as the “stereoscopic horizon”. The positions of the light-weighted centers of the first and second perspective apertures 282 and 284 are adjustable to partially overlap the first and second perspective apertures.

For the sake of clarity we represent all of the optics, optoelectronics and display technology beyond the right perspective aperture 282 and the left perspective aperture 284 in the optical path by a single subsystem that we refer to as a “stereoscopic imaging subsystem” 300. The stereoscopic imaging subsystem 300 represents all of the stereoscopic three-dimensional viewing elements disposed between the user and the two perspective apertures, 282 and 284, irrespective of technology.

The light sampled from the first portion of the single optical path and the light sampled from the second portion of the single optical path can be directed through suitable imaging lenses in the stereoscopic imaging subsystem 300 to the respective right and left eyes of a human observer to produce a stereo image pair. The stereo image pair, when viewed by the human observer creates a three dimensional view of the object 250. Alternatively the light sampled from the first portion of the single optical path and the light sampled from the second portion of the single optical path can be directed to a suitable sensor arrangement for displaying on a suitable stereo image display system the two different images that constitute a stereo image pair for creating a three dimensional view of the object 250. The stereoscopic imaging subsystem 300 can comprise a single sensor to which light sampled from the first portion of the single optical path and the light sampled from the second portion of the single optical path may be alternately directed to alternately form images of two different perspectives. In other embodiments of the present invention the light sampled from the first portion of the single optical path and the light sampled from the second portion of the single optical path may be directed to two different sensors within the stereoscopic imaging subsystem 300 and the signal be routed to a display device. Numerous further embodiments for the stereoscopic imaging subsystem 300 exist in the art and will not be further expanded upon herein.

The center of the offset aperture 272 (see FIG. 2) is disposed offset from the stereoscopic horizon along an offset aperture elevation line 275 that passes through the center of offset aperture 272 and is perpendicular to the stereoscopic horizon, and thereby perpendicular to the stereoscopic horizon line 286. It is also parallel to a perspective aperture elevation line 277 described and defined in more detail below. The distance by which the offset aperture 272 is offset from the stereoscopic horizon we refer to in the present specification as the “offset aperture elevation”, irrespective of whether the offset is positive or negative.

This arrangement is configured to produce on perspective aperture plate 280 a limited cone of illumination 274, disposed substantially mirror symmetrically with respect to the two perspective apertures, 282 and 284, but of which the centre is distinctly displaced from the horizon line 286 along a line 277, which is parallel to the offset aperture elevation line 275. Line 277 is perpendicular to the stereoscopic horizon line 286, is in the plane of perspective aperture plate 280, and is located substantially halfway between the light-weighted centers of the two perspective apertures, 282 and 284. Line 277 is referred to in this specification as the “perspective aperture elevation line”.

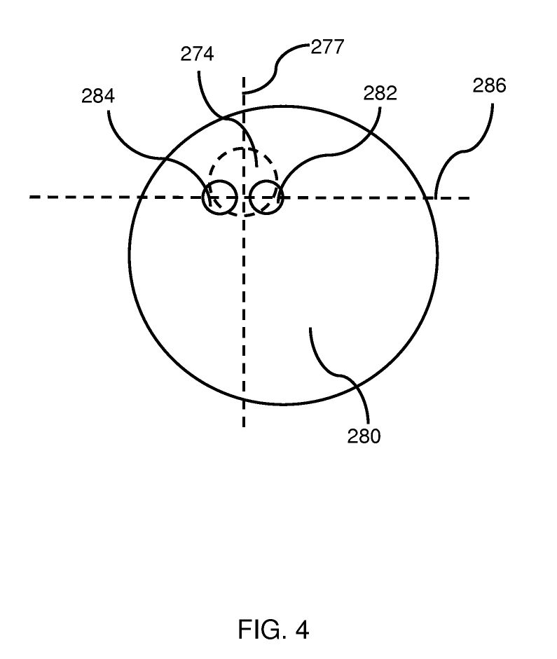

For the sake of clarity, FIG. 2 shows both the offset aperture elevation line 275 and the perspective aperture elevation line 277 as crossing the optical axis 208. In general the offset aperture elevation line 275 and the perspective aperture elevation line 277 are not limited to crossing the optical axis. In a further embodiment of the invention both the offset aperture elevation line 275 and the perspective aperture elevation line 277 are offset from the optical axis 208 within the plane of the stereoscopic horizon. The respective relative directions in which they are offset are determined by the exact lens arrangements, but in all cases the offsets are arranged to ensure that the cone of illumination 274 is positioned symmetrically with respect to the two perspective apertures 282 and 284. This condition ensures that the two perspective apertures 282 and 284 receive equal amounts of light and the resulting images in the stereoscopic image pair have the same brightness FIG. 4 shows the relationship among the two perspective apertures 282 and 284, the stereoscopic horizon line 286, the cone of illumination 274 and the optical axis 208 for such a more general situation.

As may be seen from FIG. 2, the object 250 is illuminated with light with directions within a limited cone, and this illumination is substantially the same for the two images in the stereo image pair obtained by stereoscopic imaging subsystem 300 through perspective apertures, 282 and 284.

The offset aperture 272 can be a variable aperture and its position along the offset elevation line 275 can be adjustable. The offset aperture 272 can also be positioned to be laterally offset from the center of condenser aperture plate 270. These two facilities in combination provide the ability to control the cone of illumination 274 with respect to the two system perspective apertures 282 and 284. This control over the position of offset aperture 272 provides control over both the direction of the illuminating light on the object 250 under study within its plane, and the angle the illuminating light forms with the optical axis 208. The size of the offset aperture 272 determines the spread or range of angle of incidence of the light on the object 250 under study.

Right perspective aperture 282 and a left perspective aperture 284 can be variable apertures in order to control the depth of focus of the system by changing their sizes. They can be independently changed in size. Their sizes and the positions of their light-weighted centers can be changed so that they partially overlap. Their positions with respect to each other can be adjusted so as to change the inter-aperture distance, allowing thereby control over the degree of stereopsis in the imaging apparatus 200. It bears repeating that the large numerical aperture of the typical microscope objective lens, when used for objective lens 290, naturally provides a large degree of stereopsis or difference in perspective. The stereopsis attainable from such large numerical aperture lenses is typically greater than what the human binocular vision can integrate into a three-dimensional image. There is therefore merit in suppressing this excessive stereopsis through the control of the inter-aperture distance, over and above the illumination angle control already described.

The light weighted centers of the two perspective apertures 282 and 284 are adjustable in elevation so that the stereoscopic horizon does not contain the optical axis 208. Their position is also adjustable laterally with respect to the center of the perspective aperture plate 280. This allows the two perspective apertures 282 and 284 to be positioned to exploit the beneficial positioning of the illumination cone 274. The two perspective apertures 282 and 284 can be moved in tandem to move the stereoscopic horizon with respect to the cone of illumination 274.

In one embodiment of the invention, the sample stage (not shown) of the imaging apparatus 200 can be rotated about the optical axis 208. This allows the illumination arrangement between the offset aperture 272, the illumination cone 274, and the two perspective apertures 282 and 284 to be kept fixed while the object 250 under study is rotated under these fixed illumination conditions in order to obtain the best viewing conditions.

This arrangement directly addresses the cause of the debilitating “jumping” effect resulting from Kohler type illuminators as applied to 3D imaging in a microscope, particularly when using transmission illumination. The illumination arrangement of the present invention provides all the controlled illumination advantages of a Köhler illuminator, while producing a three-dimensional image for the user at much reduced viewing discomfort. A diffuser can be disposed between the variable field aperture 240 and the condenser aperture plate 270 to enhance the uniformity of the illumination.

For the sake of clarity, the embodiment of the present invention shown in FIGS. 2 and 3 is based on simple lenses. In other embodiments of the present invention complex lens arrangements and compound lenses can allow illumination cone 274 to be on the same side of the stereoscopic horizon as the offset aperture 272.

In the embodiments described above the perspective aperture plate 280 is disposed in an aperture plane of the imaging apparatus 200. In another embodiment of the invention the perspective aperture plate, and with it perspective apertures 282 and 284, can be disposed at a conjugate of the aperture plane. In particular the conjugate of the aperture plane can be contained inside the stereoscopic imaging subsystem 300, thereby allowing the combination of aperture plate 280 and stereoscopic imaging subsystem 300 to form a single unit that can function as an accessory to a commercial imaging device such as, but limited to, a microscope, and endoscope and a macroscope. In particular, the commercial imaging device can be a non-3D imaging device. In this embodiment, an existing aperture within an existing illuminator of the imaging device can be positioned off the stereoscopic horizon of the accessory.

In a further embodiment the existing aperture of the existing illuminator can be replaced by a replacement aperture offset from the optical axis of the existing illuminator in order to produce a cone of illumination offset from a stereoscopic horizon of the accessory.

The invention has been described at the hand of a single-objective three-dimensional stereoscopic imaging apparatus, such as a microscope. The invention is not limited to microscopes and finds application also to other apparatus such as, but not limited to, 3D-endoscopes and forensic and industrial macroscopes and the like.

In accordance with a further aspect of the invention there is provided a method for obtaining a stereoscopic image pair through a single objective. The method comprises directing through the objective lens 290 a first portion of light from the object 250 to the first perspective aperture 282; directing through the objective lens 290 a second portion of light from the object 250 to the second perspective aperture 284, the light-weighted center of the second perspective aperture separated from the light-weighted center of the first perspective aperture 282 within a stereoscopic horizon by an inter-aperture distance; collecting illuminating light through the collector 230 from the light source 220; directing illuminating light from the collector 230 to the object 250; positioning off the stereoscopic horizon the offset aperture 272 disposed between the collector 230 and the object 250 to form a cone of illumination 274 at a plane of the two perspective apertures 282 and 284 substantially minor symmetrical with respect to the two perspective apertures 282 and 284; forming a first image in the stereoscopic image pair from light accepted through the first perspective aperture 282 from the first portion of light; and forming a second image in the stereoscopic image pair from light accepted through the second perspective aperture 284 from the second portion of light.

The method further comprises adjusting the inter-aperture distance to change the stereopsis of associated with the two perspective apertures 282 and 284. The method further comprises adjusting the positions of the light-weighted centers of the first and second perspective apertures 282 and 284 to partially overlap the first and second perspective apertures.

The method further comprises adjusting the sizes of at least one of the first and second perspective apertures 282 and 284 to change the depth of focus. The method further comprises adjusting the positions of the light-weighted centers of the first and second perspective apertures 282 and 284 in tandem to move the stereoscopic horizon with respect to the cone of illumination 274. The method of further comprises adjusting the position of the offset aperture 272 to move the cone of illumination 274 with respect to the stereoscopic horizon and change thereby the angle of incidence of illuminating light directed to the object 250. The method further comprises changing the size of the offset aperture 272 to change thereby the range of the angle of incidence of illuminating light directed to the object 250.

### Notes

The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

As used in this disclosure, except where the context requires otherwise, the term “comprise” and variations of the term, such as “comprising,” “comprises” and “comprised” are not intended to exclude other additives, components, integers or steps.

Also, it is noted that the embodiments are disclosed as a process that is depicted as a flowchart, a flow diagram, a structure diagram, or a block diagram. Although a flowchart may disclose various steps of the operations as a sequential process, many of the operations can be performed in parallel or concurrently. The steps shown are not intended to be limiting nor are they intended to indicate that each step depicted is essential to the method, but instead are exemplary steps only.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. It should be appreciated that the present invention should not be construed as limited by such embodiments.

From the foregoing description it will be apparent that the present invention has a number of advantages, some of which have been described herein, and others of which are inherent in the embodiments of the invention described or claimed herein. Also, it will be understood that modifications can be made to the device, apparatus and method described herein without departing from the teachings of subject matter described herein. As such, the invention is not to be limited to the described embodiments except as required by the appended claims.

### PARTS LIST

### Parts List for the Prior Art Example

108 optical axis

110 illumination system

120 source

130 collector lens

140 variable field aperture

150 object under study

160 condenser lens

170 variable condenser aperture

182 right perspective aperture

184 left perspective aperture

190 objective lens

### Parts List for the Embodiment of the Invention Described in the Figures

200 single-objective three-dimensional stereoscopic imaging apparatus

208 optical axis

210 illuminator

220 source

230 collector

240 variable field aperture

250 object under study

260 condenser lens

270 condenser aperture plate

272 offset aperture

274 cone of illumination

275 offset aperture elevation line

277 perspective aperture elevation line

280 perspective aperture plate

282 right perspective aperture

284 left perspective aperture

286 stereoscopic horizon line

290 objective lens

300 stereoscopic imaging subsystem

What is claimed is:

1. An apparatus for forming a stereoscopic image pair of an object comprising:
an objective lens disposed to collect light from the object, to direct a first portion of the light from the object to a first perspective aperture, and to direct a second portion of the light from the object to a second perspective aperture, a light-weighted center of the second perspective aperture separated from a light-weighted center of the first perspective aperture within a stereoscopic horizon by an inter-aperture distance;
an illuminator disposed to illuminate the object, the illuminator comprising a light source, a collector to collect illuminating light from the light source and direct it to the object, and an offset aperture disposed between the collector and the object and configured to be positionable off the stereoscopic horizon to form a cone of illumination at a plane of the two perspective apertures substantially mirror symmetrical with respect to the first and second perspective apertures; and
a stereoscopic imaging subsystem to form a first image in the stereoscopic image pair from light accepted through the first perspective aperture from the first portion of light and to form a second image in the stereoscopic image pair from light accepted through the second perspective aperture from the second portion of light.

2. The apparatus of claiml, wherein the inter-aperture distance is adjustable to change a stereopsis of the apparatus.

3. The apparatus of claim 1, wherein the positions of the light-weighted centers of the first and second perspective apertures are adjustable to partially overlap the first and second perspective apertures.

4. The apparatus of claiml, wherein the size of at least one of the first perspective aperture and the second perspective is adjustable to change a depth of focus of the apparatus.

5. The apparatus of claiml, wherein positions of the light-weighted centers of the first and second perspective apertures are adjustable in tandem to move the stereoscopic horizon with respect to the cone of illumination.

6. The apparatus of claiml, wherein a position of the offset aperture is adjustable to move the cone of illumination with respect to the stereoscopic horizon and change an angle of incidence of the illuminating light directed to the object.

7. The apparatus of claiml, wherein a size of the offset aperture is adjustable to change a range of the angle of incidence of the illuminating light directed to the object.

8. The apparatus of claiml, wherein the apparatus is a microscope.

9. The apparatus of claim 1, wherein the apparatus is a macroscope.

10. The apparatus of claim 1, wherein the apparatus is an endoscope.

11. An apparatus for imparting to an imaging device a facility to form stereoscopic image pairs of an object, the apparatus comprising:
a first perspective aperture disposed to accept a first portion of light from the object receivable via an objective lens of the imaging device;
a second perspective aperture disposed to accept a second portion of light from the object receivable via the objective lens of the imaging device, a light-weighted center of the second perspective aperture separated from a light-weighted center of the first perspective aperture within a stereoscopic horizon of the apparatus by an inter-aperture distance; and
a stereoscopic imaging subsystem to form a first image in the stereoscopic image pair from light accepted through the first perspective aperture from the first portion of light and to form a second image in the stereoscopic image pair from light accepted through the second perspective aperture from the second portion of light;
wherein the first and second perspective apertures are configured to be adjustably disposed substantially mirror symmetrical with respect to a cone of illumination formed off the stereoscopic horizon at a plane of the two perspective apertures by an aperture of an illuminator of the imaging device.

12. The apparatus of claim 11, wherein the inter-aperture distance is adjustable to change a stereopsis of the apparatus.

13. The apparatus of claim 11, wherein the positions of the light-weighted centers of the first and second perspective apertures are adjustable to partially overlap the first and second perspective apertures.

14. The apparatus of claim 11, wherein the size of at least one of the first perspective aperture and the second perspective is adjustable to change a depth of focus of the apparatus.

15. The apparatus of claim 11, wherein positions of the light-weighted centers of the first and second perspective apertures are adjustable in tandem to move the stereoscopic horizon with respect to the cone of illumination.

16. The apparatus of claim 11, wherein the imaging device is a microscope.

17. The apparatus of claim 11, wherein the imaging device is a macroscope.

18. The apparatus of claim 11, wherein the imaging device is an endoscope.

19. The apparatus of claim 11, wherein the aperture of the illuminator of the imaging device is a replacement aperture configured to be offset from an optical axis of the illuminator.

20. A method for forming a stereoscopic image pair of an object comprising:
directing through an objective lens a first portion of light from the object to a first perspective aperture;
directing through the objective lens a second portion of light from the object to a second perspective aperture, the light-weighted center of the second perspective aperture separated from the light-weighted center of the first perspective aperture within a stereoscopic horizon by an inter-aperture distance;
collecting illuminating light through a collector from a light source;
directing illuminating light from the collector to the object;
positioning off the stereoscopic horizon an offset aperture disposed between the collector and the object to form a cone of illumination at a plane of the two perspective apertures substantially minor symmetrical with respect to the two perspective apertures;
forming a first image in the stereoscopic image pair from light accepted through the first perspective aperture from the first portion of light; and
forming a second image in the stereoscopic image pair from light accepted through the second perspective aperture from the second portion of light.

21. The method of claim 20, further comprising adjusting the inter-aperture distance to change a stereopsis associated with the two perspective apertures.

22. The method of claim 20, further comprising adjusting the positions of the light-weighted centers of the first and second perspective apertures to partially overlap the first and second perspective apertures.

23. The method of claim 20, further comprising adjusting the size of at least one of the first perspective aperture and the second perspective aperture to change a depth of focus.

24. The method of claim 20, further comprising adjusting the positions of the light-weighted centers of the first and second perspective apertures in tandem to move the stereoscopic horizon with respect to the cone of illumination.

25. The method of claim 20, further comprising adjusting a position of the offset aperture to move the cone of illumination with respect to the stereoscopic horizon and change an angle of incidence of illuminating light directed to the object.

26. The method of claim 20, further comprising adjusting a size of the offset aperture to change a range of the angle of incidence of illuminating light directed to the object.
